(19) United States
(12) Patent Application Publication
(10) Pub. No.: US 2009/0057290 A1
(43) Pub. Date: Mar. 5, 2009

(54) Electrically heated articles of apparel having variable heating characteristics and methods of making same

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 11/899,425

(22) Filed: Sep. 5, 2007

(51) Int. Cl. H05B 3/00

(52) U.S. Cl. 219/211; 29/592.1

(57) ABSTRACT

Electrically heated articles of apparel and methods of making the same. The electrically heated articles of apparel include a flexible heating harness that includes a plurality of resistance heater elements made of silver plated yarn having a core comprising a single strand of spandex about which a plurality of silver plated strands of nylon filaments is wound. The heater harness is disposed between liners constructed from fabric or waterproof membranes.

### BACKGROUND OF THE INVENTION

1. Field of the Invention

The present invention relates generally to electrically heated articles of apparel and methods of making the same. More particularly, the invention concerns an electrically heated diving glove having variable heating characteristics and the method of making the glove.

2. Discussion of the Prior Art

Various types of heated garments, including heated gloves have been suggested in the past. Batteries are typically used in these prior art garments to provide the source of electrical power to heat various types of heating elements, such as fine wires, that are embedded in the material from which the garment is fabricated. During use of the garment the heating elements are frequently subjected to undue stress that causes degradation and ultimate failure. Moreover, due to their bulk and lack of flexibility, the prior art garments are often cumbersome and uncomfortable in use. Additionally, because the length of the heating elements that, due to electrical resistance, heat the prior art garments, typically vary in length and, therefore, vary in resistance, the prior art garments are generally randomly heated unevenly.

It is an object of the present invention to provide an electrically heated article of apparel that comprises a plurality of strategically located heating zones that are heated by a novel, yieldably deformable heater harness that comprises a plurality of thin interconnected, electrically conductive yarn-like members that are constructed from selected stretchable fibers, the electrical resistivity of which remains unchanged as the yarn-like members are stretched.

### SUMMARY OF THE INVENTION

It is an object of the present invention to provide an electrically heated, multi-layered article of apparel that is heated by a flexible heating harness that is disposed between the layers of the article and is constructed from silver-plated yarn. More particularly, it is an object of the invention to provide an article of apparel of the aforementioned character that comprises a controllably heated glove having variable heating characteristics that can be used for diving.

Another object of the invention is to provide a battery powered heated diving glove as described in the preceding paragraph, a battery powered heated glove that permits divers to maintain functionality of their hands in waters as cold as 0° Celsius for periods of up to 4 hours. In this regard, it is an object of the invention to provide a diver's glove that has as many as twenty heat zones with wattages and amperages required to heat the various zones of the hands to optimum temperatures as determined by the physiology of the human hand.

Another object of the invention is to provide an electrically heated diving glove as described in the preceding paragraph in which the flexible heating harness is constructed from silver-plated yarn made up of two connectors attached to each of two busses, one for the negative pole, the other for the positive pole, and a plurality of heater elements, each heater element being of varying length and varying electrical resistance.

Another object of the invention is to provide an electrically heated diving glove as described in the preceding paragraphs in which the flexible heating harness can effectively withstand the stresses caused by movement of the diver's hand.

Another object of the invention is to provide an electrically heated article of apparel as described in the preceding paragraphs that exhibits substantially uniform stretch-and-return characteristics.

Another object of the invention is to provide an electrically heated article of apparel of the class described in which the flexible heating harness comprises a plurality of resistance heater elements made of silver-plated yarn having a core comprising a single strand of 10 to 40 denier spandex about which a plurality of silver-plated strands of nylon filaments is wound.

Another object of the invention is to provide a method of making an electrically heated article of apparel as described in the preceding paragraph that includes the step of pre-treating the yarn with an activator that is only effective on the strands of nylon filaments and leaves the spandex core unaffected. Accordingly, during the silver-plating step, the silver only adheres to the strands of nylon and leaves the spandex core un-plated.

Another object of the invention is to provide an article of apparel of the character described that includes a controller assembly that is operably associated with the heating harness for controlling the temperature thereof.

Another object of the invention is to provide an electrically heated article of apparel as described in the preceding paragraphs that is easy-to-don, comfortable to wear and uniformly heats the portion of the user's body that is covered by the article of apparel.

Another object of the invention is to provide an electrically heated article of apparel of the class described that has the general shape of a human hand.

Another object of the invention is to provide an article of apparel as described in the preceding paragraphs that is attractive in appearance and highly reliable in use.

The forgoing as well as other objects of the invention will be realized by the inventions described more fully in the paragraphs that follow.

### BRIEF DESCRIPTION OF THE DRAWINGS

FIG. 1 is a generally perspective view of one form of the electrically heated diving glove of the invention.

FIG. 2 is a greatly enlarged, generally perspective view of the area designated in FIG. 1 as 2-2.

FIG. 3 is a top plan view, partly broken away, to show internal construction of the electrically heated glove of the invention in position over a rigid, generally hand-shaped mandrel.

FIG. 4 is a greatly enlarged, cross-sectional view taken along lines 4-4 of FIG. 3.

FIG. 5 is a top plan view illustrating the construction of one form of the heater harness component of the invention.

FIG. 6 is a top plan view showing the heating harness affixed to the intermediate-liner component of the electrically heated glove of the invention and showing the assemblage in position over the rigid, generally hand-shaped mandrel.

FIG. 7 is a bottom plan view of the assemblage shown in FIG. 6.

FIG. 8 is a top plan view of one form of the apparatus of the invention for constructing the heating harness component of the electrically heated glove.

FIG. 8A is a greatly enlarged view of the area designated in FIG. 8 as “8A”.

FIG. 9 is an enlarged view of one of the multi-segment, heater arms of the heating harness interconnected with the positive and negative buses of the heating harness.

FIG. 10 is a generally illustrative view showing one form of the heater harness of the invention as it appears in position over the back of the user's hand.

FIG. 11 is a generally illustrative view, similar to FIG. 10, showing one form of the heater harness of the invention as it appears in position over the front of the user's hand.

FIG. 12 is a side-elevational view of one form of the platen press assembly used in carrying out one form of the method of the invention.

FIG. 13 is a micro-photograph at 720 magnification of a portion of one form of the yarn used to construct the heating harness component of the electrically heated glove of the invention.

FIG. 14 is a micro-photograph illustrating the appearance of the yarn used to construct the heating harness component with the yarn shown as it appears at varying degrees of tension.

FIG. 15 is a top plan view showing the heating harness affixed to the intermediate, elastomeric membrane liner component of the electrically heated glove of the invention and showing the assemblage in position over the rigid, generally hand-shaped mandrel.

FIG. 16 is a bottom plan view of the assemblage shown in FIG. 15.

FIG. 17 is a top plan view showing a second elastomeric membrane liner component in position over the assemblage shown in FIGS. 15 and 16 and showing the outer component, or outermost layer of the electrically heated glove of the invention in position over the second elastomeric membrane liner component.

FIG. 18 is a greatly enlarged cross-sectional view taken along lines 18-18 of FIG. 17.

### DESCRIPTION OF THE INVENTION

As used herein, the following terms have the following meanings:

The term “fabric” as used herein means a material of any kind that is woven, spun, braided or knit from fibers, either vegetable, animal, or man made synthetics.

The term “mandrel” as used herein means a rigid, generally planar, relatively thin support member having the general shape of an article of apparel.

The term “spandex” as used herein means a long-chain synthetic polymeric fiber. Soft and rubbery segments of polyester or polyether polyols allow the fiber to stretch up to 600% and then recover to its original shape.

The term “denier” as used herein means a unit of weight indicating the fineness of fiber filaments and yarns, both silk and synthetic, and equal to a yarn weighing one gram per each 9,000 meters: used especially in indicating the fineness of women's hosiery.

The term “silver-plating” as used herein means a process for plating metallic silver onto an object, such as a process commonly known as “electroless-plating.”

The term “plate” as used herein means to coat (metal) with a thin film of gold, silver, nickel, etc., by mechanical or chemical means.

The term “plait” as used herein means to braid, as hair or straw.

The term “snap fastener” as used herein means a closure device consisting of a closure unit and attaching unit, which when interconnected, complete an electrical circuit.

The term “battery” as used herein means a device that stores chemical energy and makes it available in an electrical form.

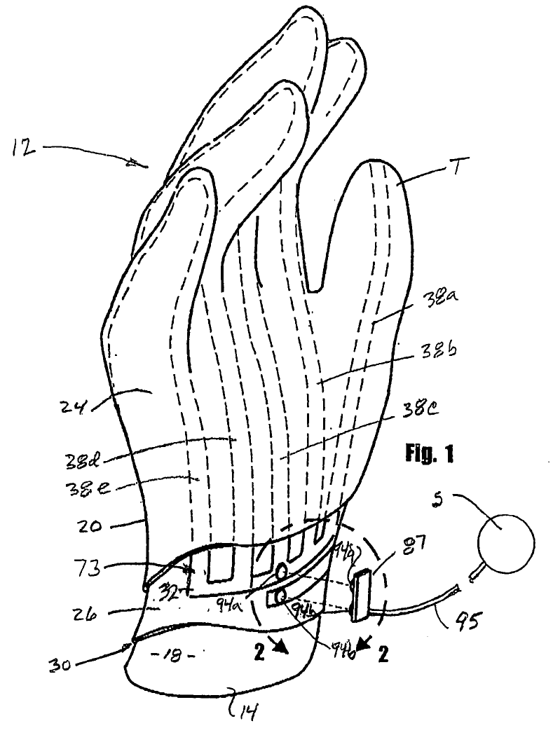

Referring now to the drawings and particularly to FIGS. 1 through 4, one form of the electrically heated article of apparel of the present invention, here shown as a glove is there illustrated and generally designated by the numeral 12. As best seen in FIGS. 1, 3 and 4, the electrically heated glove 12 comprises a three-ply construction that includes a user contact, or inner glove portion, 14 having inner and outer surfaces 16 and 18 and an outer glove portion 20 having inner and outer surfaces 22 and 24. Disposed intermediate portions 14 and 20 is a liner glove portion 26 having inner and outer surfaces 28 and 29.

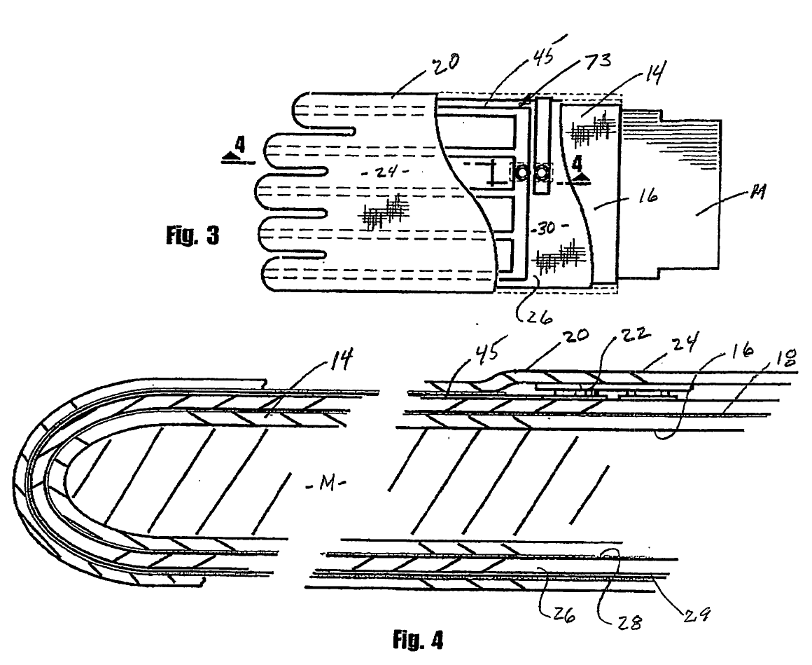

In FIGS. 3 and 4 the glove 12 is shown mounted on a relatively thin, generally hand-shaped aluminum mandrel “M”.

Glove portions 14, 20 and 26 can be constructed in various ways from a number of different types of materials, including elastomers, composites and fabrics made by knitting and weaving processes well understood by those skilled in the art. However, the glove portions of the present invention are preferably knit using a yarn sold by E. I. du Pont de Nemours and Company under the name and style NOMEX. For reasons presently to be described, the yarn preferably includes a Spandex core. Spandex comprises a long-chain synthetic polymeric fiber. Soft and rubbery segments of polyester or polyether polyols allow the fiber to stretch up to 600% and then recover to its original shape. Hard segments, usually urethanes or urethane-ureas, provide rigidity and so impart tensile strength and limit plastic flow. The knitting of the glove components can be accomplished using various types of knitting machines, including machines made by Shima Seiki, Ltd., of Wakayama, Japan. It is to be understood that various types of natural, as well as man-made synthetic fibers can be used to construct the glove components of the invention.

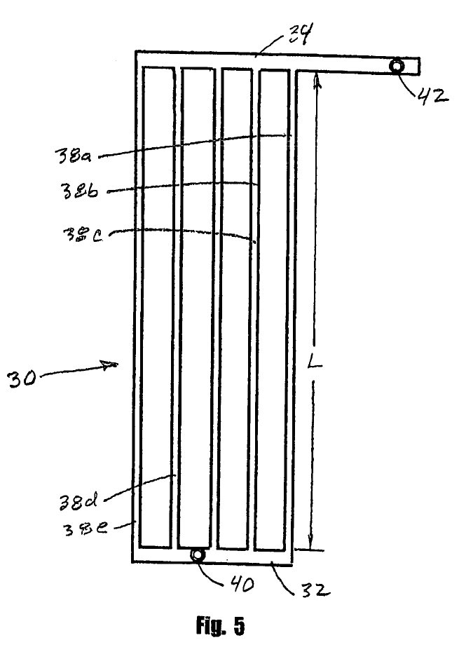

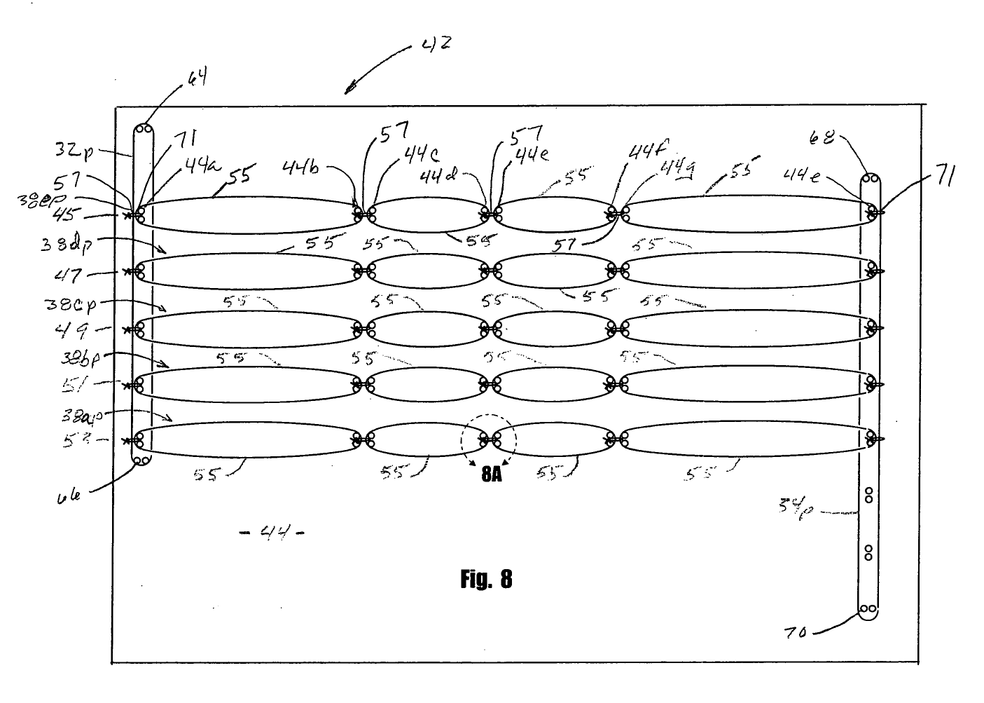

As illustrated in FIG. 5 of the drawings, the important heating harness 30 component of the invention here comprises an elongated, positive bus 32 constructed from a silver-plated yarn and an elongated negative bus 34 also constructed from a silver-plated yarn. Heating harness 30 also includes a plurality of elongated, stretchable heater arms 38a, 38b, 38c, 38d and 38e that are constructed from a silver-plated yarn and are interconnected with the first and second bus portions in a manner illustrated in FIGS. 5, 8, 9 and 10. The extremities of the heater arms 38a, 38b, 38c, 38d and 38e can be connected to the bus portions 32 and 34 in any suitable manner, such as by tying in a conventional manner using strands of silver-plated yarn as shown in FIG. 8 of the drawings, by adhesive bonding, clamping, stapling and similar methods. In the preferred form of the method of the invention, one end of each of the heater elements is tied to the first bus 32 by ordinary methods, using strands of silver-plated yarn (FIG. 8). The opposite end of each heater element is then tied to the other bus 34 in a similar manner. Uniquely, the heater elements in their relaxed state are flexible and, in a manner presently to be described, can readily be stretched and bent as necessary.

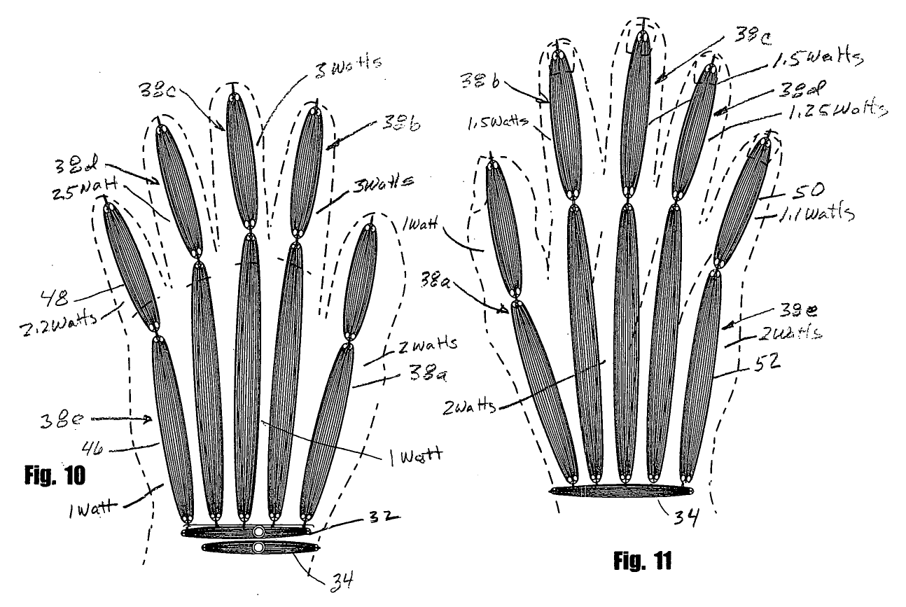

An extremely important aspect of the present invention is the method by which the buses 32 and 34 and the elongated, heater arms 38a, 38b, 38c, 38d and 38e are constructed to form a novel heater harness that can be embodied in a diver's glove to form a glove that has a plurality of heat zones (to 20) with wattages and amperages required to heat the various zones of the hands of the diver to optimum temperatures as determined by the physiology of the human hand. In order to construct such a unique glove, each of the elongated, stretchable heater arms must exhibit a predetermined, varied electrical resistance along its length. In accordance with one form of the method of the invention this is accomplished by constructing each heater arm from a plurality of distinct segments of different electrical resistivity, each segment being made up of a different number of strands of silver-plated yarn and typically being of a different length. In this way, when the heater element is embodied within the glove, each segment of each heater arm can be strategically arranged to cover a selected portion of the diver's hand and thereby heat that portion of the hand to the desired temperature (see FIGS. 10 and 11 where the heater arms, each comprising a plurality of heating segments of different resistivity, are strategically positioned over the front and back of the hand).

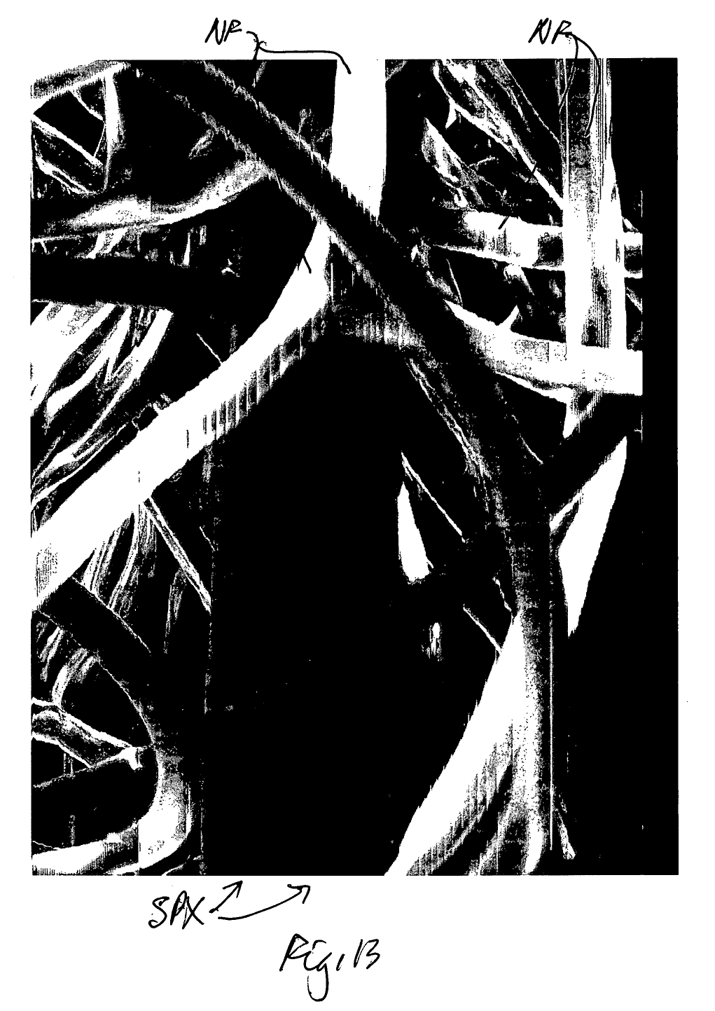

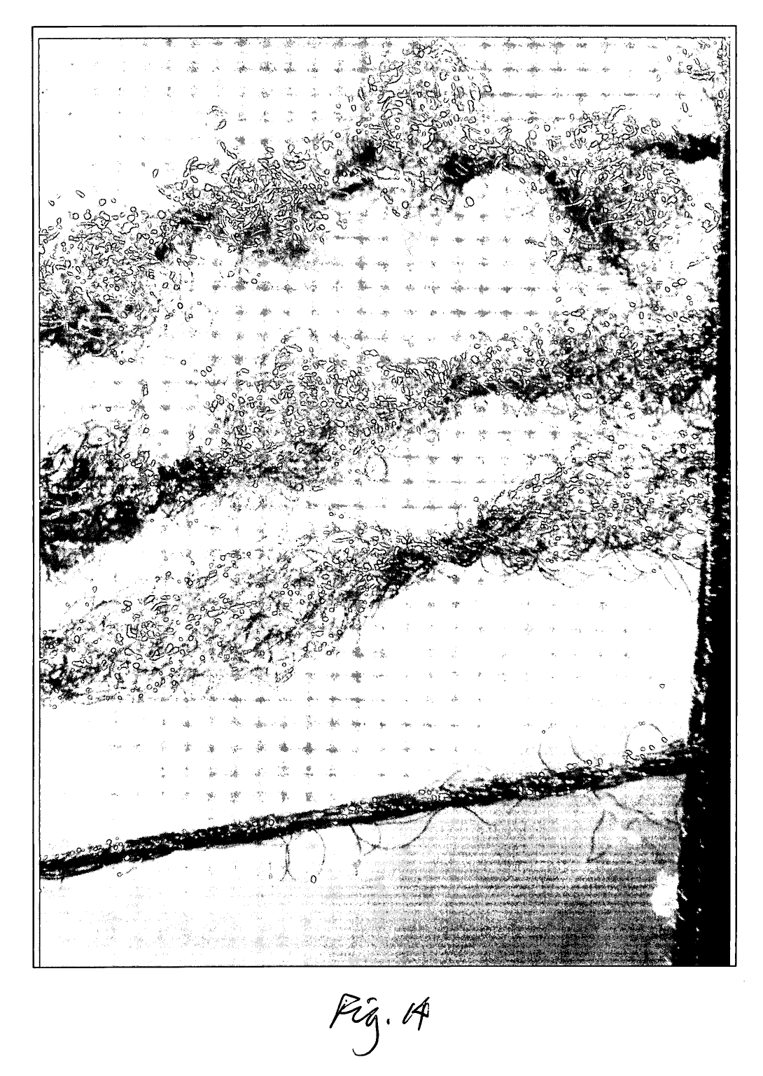

The silver-plated yarn used to construct the heater arms as well as the first and second buses 32 and 34 is preferably a silver-plated nylon yarn comprising a core of a single strand of 20 denier Spandex and a covering of 70 denier type 6.6 textured nylon consisting of 68 strands of nylon filaments. FIGS. 13 and 14, which will be discussed in greater detail hereinafter, comprise micro-photographs that illustrate one form of the yarn that is used to construct the heater arms and buses of the electrically heated harness of the invention.

In accomplishing electroless-plating of the yarn with elemental silver, a special activator is used to pre-treat the yarn. The activator is only effective on the nylon filaments leaving the spandex core unaffected. As a result, during the plating step the silver only adheres to the nylon filaments leaving the spandex core free of silver. The physical diameter of the 70 denier nylon yarn is less than 0.003 inches. A company capable of accomplishing the silver-plating step described herein is Carolina Silver Technologies LLC of Valdese, N.C. Further details concerning this electroless-plating process can be obtained from this company.

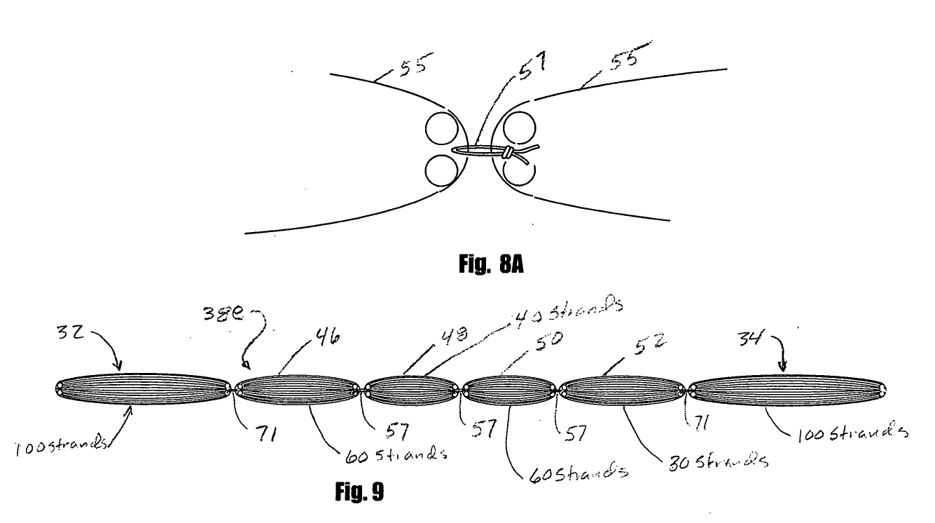

Turning to FIG. 8 of the drawings, one form of the apparatus of the invention for constructing the novel, stretchable heater arms that make up the electrically heated harness is there shown and generally designated as 42. Apparatus 42 here comprises a layout board 44 having a plurality of spaced-apart dowels that are arranged in a predetermined pattern. As illustrated in FIG. 8, the dowels are arranged in spaced-apart rows 45, 47, 49, 51 and 53 with each row comprising spaced-apart pairs of dowels about which is wound the silver-plated yarn that is used to construct the heater arms of the heating harness. More particularly, spaced-apart pairs of dowels 44a and 44b are used to construct a first segment 46 of the heater arm 38e, while spaced-apart pairs of dowels 44c and 44d are used to construct a second segment 48 of the heater arm 38e (see FIG. 9). In similar fashion, spaced-apart pairs of dowels 44e and 44f are used to construct a third segment 50 of the heater arm 38e and a spaced-apart pair of dowels 44g and 44f are used to construct a fourth segment 52 of the heater arm 38e.

In accordance with one form of the method of the invention, the electrical load capacity for each of the segments 46, 48, 50, and 52 is determined by how many times the strands of silver yarn 55 is wrapped around the set of four pegs used to construct a particular segment. It is apparent that the greater number of wraps used to form a particular segment will reduce the electrical resistance of that segment. Conversely, a fewer number of wraps used to form a particular segment will increase the electrical resistance of that segment. Additionally, the length of the heater element, as determined by the distance between the sets of dowels will also determine the electrical resistance of the particular segment. Obviously, the longer the heater segment, the higher the electrical resistance and the shorter the heater segment the lower will be the electrical resistance. It is apparent that in the design of the heating harness the length of each heating segment must be tailored to suit the dimension of the portion of the glove which the heater segment will affect (see FIGS. 10 and 11). Once the dimensional considerations are satisfied, the electrical resistance of a particular segment can be satisfied by increasing or reducing the number of wraps of the silver-plated yarn used to construct a particular segment. In this regard, in constructing each heater arm the operator will preferably wrap the silver-plated yarn in a fully stretched condition about each set of dowels such as dowels 44a and 44b, a predetermined number of times to form the segment 46, will then tie-off that segment in the manner shown in FIG. 9 of the drawings and will then move on to the next set of dowels, such as dowels 44c and 44d. After completing the predetermined number of wraps of silver-plated yarn about this set of dowels to form the second segment 48, the operator will tie-off that segment and move on to the next set of dowels to construct the third segment 50. In FIGS. 8 and 8A of the drawings, the segments are shown interconnected by tying with strands of yarn 57. However it should be understood that the segments can be interconnected by various means including tying, clamping, stapling, adhesive bonding and the like.

Following the completion of the construction of the heating arm 38e, the operator will move on to the next row 47 of spaced-apart dowels to construct the second heating arm 38b in the same manner as described in connection with the construction of the heating arm 38e. Like heating arm 38e, heating 38d will be made up of four separate and distinct heating segments of the character shown in FIGS. 10 and 11 of the drawings This done, the operator will sequentially move on to rows 47, 49, 51 and 53 to construct heating arms, 38c, 38b and 38a in the same manner as described in connection with the construction of heating arm 38e. Like heating arm 38e, each of the heating arms 38d, 38c, 38b and 38a, which are identified in FIG. 8 as precursor arms 38dp, 38cp, 38bp and 38ap, which comprise only single wrappings of yarn, are made up of strategically constructed, spaced-apart segments that are adapted to cover particular portions of the diver's hand in the manner illustrated in FIGS. 10 and 11 of the drawings.

Upon completion of the heating arms 38a, 38b, 38c 38d and 38e in the manner described in the preceding paragraphs, construction of the first and second buses 32 and 34 can be accomplished by wrapping the silver-plated yarn 55 a predetermined number of times about selected spaced-apart pairs of dowels provided on the layout board. In this regard, the busses must be made up of a sufficient number of strands of silver-plated yarn to carry the electrical power without excessive heating and, therefore, may have more strands, than do the individual heating arms.

In accordance with one form of the invention, construction of the first bus 32 (identified in FIG. 8 has 32p) is accomplished by wrapping in the silver-plated yarn 55 a predetermined number of times about spaced-apart pairs of dowels 64 and 66 that are provided on the layout board 44. Following the construction of the first bus 32, one of each of the heating arms 38a, 38b, 38c 38d and 38e is interconnected with the first bus 32 by any suitable means such as tying, clamping, stapling or adhesive bonding. In similar fashion, second bus 34 (identified in FIG. 8 as 34p) can be constructed by wrapping in the silver-plated yarn 55 a predetermined number of times about spaced-apart pairs of dowels 68 and 70 that are provided on the layout board 44. When construction of the second bus 34 is completed the completion of the heating harness is accomplished by interconnecting the other end of each of the heating arms 38a, 38b, 38c 38d and 38e with the first bus 32 by any suitable means such as tying, clamping, stapling or adhesive bonding (see FIG. 9 wherein the connection of the first and second buses to the heating arms is shown as being accomplished by tying the heating arms to the heating harness with a length of yarn 71).

FIG. 9 of the drawings represents one example of the number of wraps used to form each of the busses and the number of wraps used to form each of the first, second, third and fourth segments of elongated heater element 38b of the heating harness. In this example each of the busses 32 and 34 are formed using 50 wraps about dowels 64 and 66 and dowels 68 and 70 respectively to form buses having 100 strands of yarn. Similarly, in this example, and for illustrative purposes, segment 46 which extends over the back of the hand is formed using 30 wraps of silver-plated yarn around pairs of dowels 44a and 44b to form a segment having 60 strands of yarn, while segment 48 which covers the back of the little finger is formed using 20 wraps of silver-plated yarn around pairs of dowels 44c and 44d to form a segment having 40 strands of yarn. In similar fashion segment 50 which covers the palm side of the little finger is formed using 30 wraps of silver-plated yarn around pairs of dowels 44e and 44f to form a segment having 60 strands of yarn, while segment 52 which covers the palm portion of the hand is formed using 15 wraps of silver-plated yarn around pairs of dowels 44g and 44f to form a segment having 30 strands of yarn.

It is to be understood that in forming the segments of each of the heating arms of the heating harness, the number of wraps of yarn used to form the particular segment will vary from segment to segment and will be predetermined based on the electrical resistance of the segment that is required to provide desired optimum temperature of the particular segment as determined by the physiology of the diver's hand. For example, FIGS. 10 and 11 of the drawings illustrate, by way of example, the heat distribution (described in terms of Watts ranging from between about 1 Watt and about 3 Watts) that might be desired to be produced by the particular segments of the heating harness at various areas of the front and back of the diver's hand.

Following the completion of the construction of the heating harness, the next step in the preferred form of the method of the invention is to coat the silver-plated harness with an electrically insulating material, such as a ultra-violet cured polyurethane elastomeric polymer to form an insulated harness 73. The coating process, which is of a character well understood by those skilled in the art, produces a coating that is waterproof, one which exhibits a shore hardness of approximately 80 A and one that has a stretch quality at least 100% before rupture.

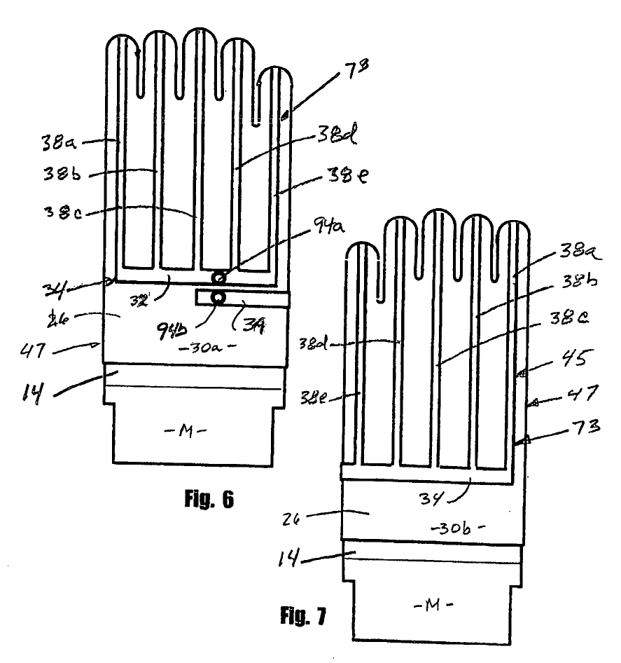

In carrying out the method of the invention for constructing the three-ply, insulated, electrically heated glove of the invention, the first step is to position the user contact, or inner glove portion, 14 over the previously mentioned sheet aluminum, generally planar mandrel “M” to form a first sub-assembly. This done, the inner-liner 26 is stretched over the first sub-assembly to form a second sub-assembly. Next, the insulated harness 73 is affixed to the inner-liner 26 by means of a temperature-activated, thermo-setting adhesive. More particularly, this adhesive bonding step is accomplished by first placing a suitable adhesive unto the inside, or lower, face of the insulated heater harness 73 to form a coated insulated heating harness. One suitable adhesive for accomplishing this process is a powdered heat-activated adhesive made by Ems Chemie U.S.A. of Sumpter, S.C. In accomplishing the bonding step, the insulated harness is laid flat on a level surface with the inside face exposed. With the insulated harness in this position, the powdered adhesive is sprinkled onto the harness face and is then fused thereto in a manner well understood by those skilled in the art through the use of a radiant heater operating at a temperature sufficient to activate the adhesive. Next, the adhesive-covered, or coated, insulated harness is placed onto the exposed, or outer, surface of the liner component 26 with the powdered adhesive-coated side bearing against the knit glove and arranged as shown in FIGS. 6 and 7 of the drawings to form a precursor glove assembly 47 having an outer surface. As depicted in FIG. 3, the buses 32 and 34 are located a precise distance from the fingertips of the glove and bus 34 is wrapped around the edge of the assemblage to bring the connection point to the back side of the wrist.

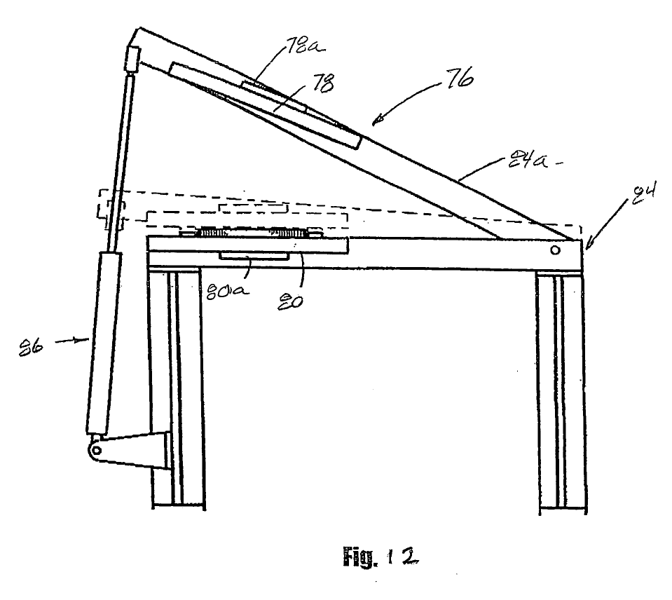

The precursor glove assembly 73 thus formed is then heated and compressed in an appropriate platen press 76, such as that shown in FIG. 12 of the drawings, with both platens 78 and 80 being heated to a temperature of about 375° F. for several minutes.

As shown in FIG. 12, the platen press assembly here comprises a supporting frame 84 to which a lower platen 76 is suitably affixed. Pivotally connected to frame 84 is a pivoting frame assembly 84a to which upper platen 78 is pivotally connected. At least one conventional air cylinder assembly 86 is connected to supporting frame 84 to controllably move the pivoting frame assembly 84a from the first open position shown by the solid lines in FIG. 12 to the second closed position shown by the phantom lines in FIG. 12. Platens 78 and 80 are controllably heated by means of conventional electric-resistance elements 78a and 80a which are mounted in intimate contact with the platens. Platens 78 and 89 are preferably massive pieces of aluminum which provide a heat sink. The temperature of each platen is continuously monitored by a suitable thermal controller of a character well known in the art (not shown) utilizing a thermocouple affixed to the platen (not shown).

This combination heating and compression step of the method of the invention activates the adhesive so as to securely and simultaneously bond the insulated heater harness 73 to both sides (that is, the back of hand side 30a and palm side 30b) of the liner component 26 simultaneously to form a cured precursor glove assembly (see FIGS. 6 and 7).

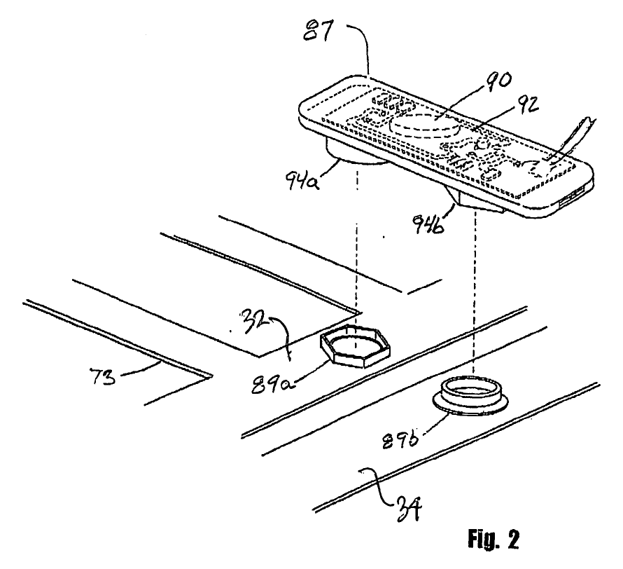

In practice, the negative bus 34 is constructed so that when it is in a relaxed condition its length will be slightly less than the dimension required to traverse from the wrist on the back of the hand to the wrist on the front of the hand. Accordingly, when is it is affixed to the inner-liner 26 in the manner shown in FIGS. 2 and 3 of the drawings it will be somewhat stretched. Similarly, the heating arms 38a, 38b, 38c, 38d and 38e, which interconnect the positive and negative buses, will be constructed so that the length of each of the arms in its relaxed state is approximately equal to the relaxed length “L” of the arm 38a (FIG. 5) that extends from the positive bus 32 over the thumb portion “T” of the glove (FIG. 1) and on to the negative bus 34. For example, the relaxed length of the arm 38a should be such that as the yarns are extended from the bus 32 over the thumb portion and to the negative bus 34 it will be somewhat stretched. Similarly, the length of each of the remaining arms is such that each yarn will be slightly stretched as the arm extends from the positive bus 32 over a selected one of the finger portions of the glove and to the negative bus 34 in a manner shown in FIGS. 1, 10 and 11 of the drawings. With this unique construction, each of the stretched arms, being of the same length in their relaxed state, will still exhibit the same electrical resistivity because the texturized, silver-plated conductive fibers that form the heater arms, while straightened, have not been lengthened.

Referring once again to FIGS. 13 and 14 of the drawings, FIG. 13, which is a micro-photograph of a section of the yarn used in accomplishing the method of one form of the invention, one stand of Spandex (made-up of two cylindrical elements), identified in the drawing as “SPX”, is shown surrounded by a multiplicity of nylon filaments that are identified as “NF”. As illustrated in FIG. 13, the nylon filaments, which appear in a relaxed configuration, form a random “bird nest like” configuration that circumscribes the strands of Spandex. A section of this same type of yarn is shown at a lesser magnification in the top portion of FIG. 14. At the lower portion of FIG. 14, the nylon strand is shown as it appears in a stretched configuration illustrating the manner in which the nylon filaments straighten and closely conform to the spandex elements. At the intermediate portions of FIG. 14, the yarn a shown in a partially stretched configuration.

The next step in one form of the method of the invention for making an electrically heated three-ply glove is to coat the outer surface of the cured precursor glove assembly with an adhesive to form an adhesive-coated cured precursor glove assembly. This done, the adhesive is then fused to the outer surface in a manner well understood by those skilled in the art through the use of a radiant heater operating at a temperature sufficient to activate the adhesive. With the adhesive-coated, cured precursor glove assembly still in position over the mandrel “M”, the outer fabric portion 20 is placed over the adhesive-coated, cured second sub-assembly with the inner face 22 thereof in engagement with the adhesive-coated, cured second sub-assembly. The assemblage thus formed is then compressed in a manner to urge the outer fabric portion 20 into engagement with the adhesive-coated cured sub-assembly to form a precursor article. This compression step is accomplished using the platen press shown in FIG. 12 of the drawings and is carried out in a manner similar to the method for making the cured precursor glove assembly. More particularly, with both platens 78 and 80 heated to a temperature of about 375° F., which is sufficient to bond said outer fabric portion 20 to the adhesive-coated cured second sub-assembly, the assemblage is placed under compression for several minutes. This step in the method of the invention activates the adhesive so as to securely and simultaneously bond together the adhesive-coated cured second sub-assembly and the outer fabric portion 20. With this construction, the insulated heater harness 73 is securely captured between the inner layer components 30 and the outer layer components 22, which here comprise fabric components or liners, to appropriately form the three-ply precursor article of the invention.

The final step in the method for forming the three-ply electrically heated glove of the invention is to interconnect the controller assembly 87 with the electrical connectors 89a and 89b in a manner depicted in FIG. 2 of the drawings. In the present form of the invention the controller assembly 87 includes a battery 90 that is interconnected with a circuit board 92 that is, in turn, connected to electrical connectors 94a and 94b that mate with electrical connectors 89a and 89b. When the electrical connectors are appropriately interconnected, electrical power can be supplied to the electrical harness to heat it to the desired elevated temperature as a result of the resistance caused by the elongated heating arms of the electrical harness. The nature and size of the battery 90 depends largely on the end use to be made of the glove.

As illustrated in FIGS. 1 and 2, in one form of the invention the controller 87 can be interconnected via a conductor 95 and appropriate switching with an external source of electrical power “S” which may comprise a conventional DC power pack as, for example, a power pack carried about the waist of the user, or, alternatively, a source of alternating electrical current.

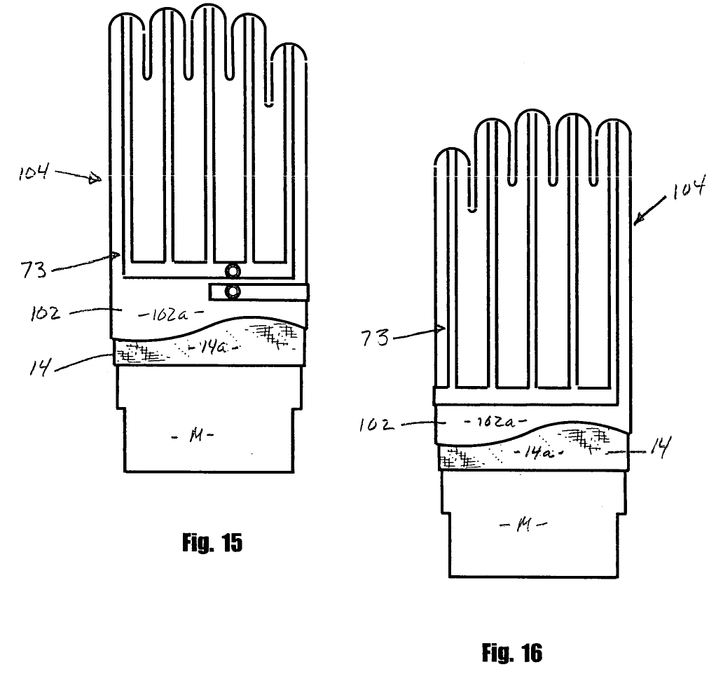

Referring next to FIGS. 15 through 18, the method and apparatus of the invention for constructing a four-ply electrically heated, waterproof glove of the invention is there shown. This method and apparatus is similar in many respects to that shown in FIGS. 1 through 14 and like numerals are used in FIGS. 15 through 18 to identify like components. This latest method of the invention includes the steps of first stretching the inner liner 14 over the previously mentioned sheet aluminum generally planar mandrel “M” in the manner illustrated in FIGS. 15 and 16 of the drawings to form a first sub-assembly. The next step in this latest form of the method of the invention is to coat the outer surface 14a of the inner liner 14 with a heat-activated, thermo-setting adhesive of the same character used in performing the previously described method of the invention. This done, the adhesive is then fused to the outer surface of the inner liner in a manner well understood by those skilled in the art through the use of a radiant heater operating at a temperature sufficient to activate the adhesive.

The next step in this latest form of the invention is to place a relatively thin waterproof polyurethane membrane 102 having a thickness of between about 0.001 inches and about 0.040 inches over the assemblage 104 that is made up of the inner liner 14 and the mandrel “M”. This done, the outer surface 102a of membrane 102 is coated with a heat-activated, thermo-setting adhesive of the character previously described. The adhesive is then fused to the outer surface of the membrane in a manner well understood by those skilled in the art through the use of a radiant heater operating at a temperature sufficient to activate the adhesive.

Next, the insulated heating harness 73 is constructed in the same manner as previously described using the same materials, namely the yarn 55. Following completion of the construction of harness 73, the insulated harness is affixed to the membrane 102 by means of a temperature-activated, thermo-setting adhesive. More particularly, this adhesive bonding step is accomplished by first placing an adhesive of the character previously described unto the inside, or lower face of the insulated heater harness 73 to form a coated insulated heating harness. In accomplishing the bonding step, the insulated harness is laid flat on a level surface with the inside face exposed. With the insulated harness in this position, the powdered adhesive is sprinkled onto the harness face and is then fused thereto in a manner well understood by those skilled in the art through the use of a radiant heater operating at a temperature sufficient to activate the adhesive. Next, the adhesive-covered, or coated, insulated harness is placed onto the exposed, or outer, surface 102a of the membrane 102 with the powdered adhesive-coated side bearing against the membrane and arranged as shown in FIGS. 15 and 16 of the drawings to form a two ply precursor glove assembly 104. As in the earlier described method of the invention, and as shown in FIGS. 15 and 16, the buses 32 and 34 are located a precise distance from the fingertips of the glove and bus 34 is wrapped around the edge of the assemblage to bring the connection point to the back side of the wrist.

The precursor glove assembly 104 thus formed is then heated and compressed in an appropriate platen press 76, such as that shown in FIG. 12 of the drawings with both platens 78 and 80 being heated to a temperature of about 375° F. for several minutes.

After the insulated harness 73 has been bonded to membrane 102, the next step in this latest form of the invention is to interconnect the controller assembly 87 with the electrical connectors 94a and 94b in a manner previously described. When the electrical connectors are appropriately interconnected, electrical power can be supplied to the electrical harness to heat it to the desired elevated temperature as a result of the resistance caused by the elongated heater arms of the electrical harness.

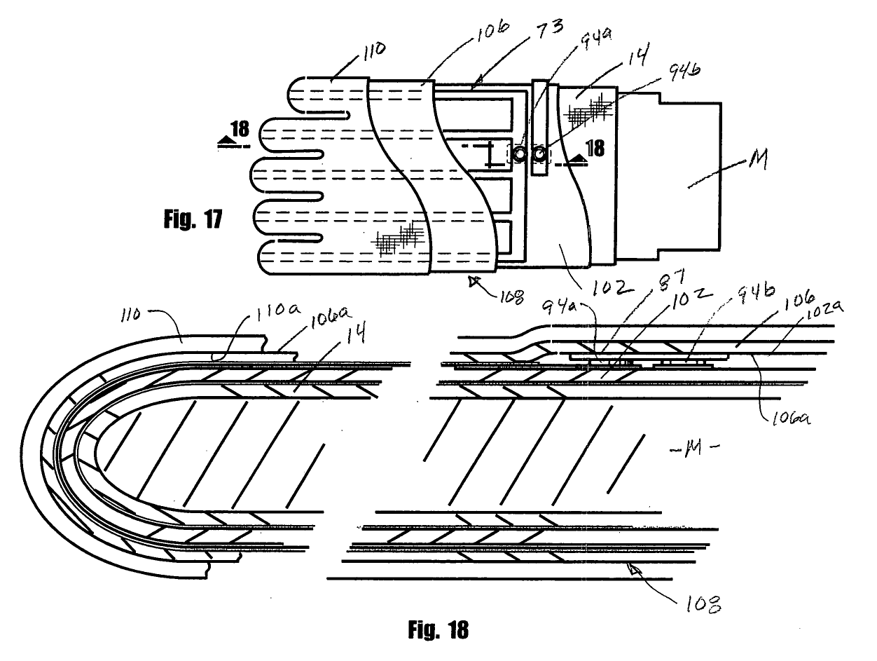

Following inter-connection of the controller assembly 87 with the electrical connectors 94a and 94b, a second relatively thin waterproof polyurethane membrane 106 having a thickness of between about 2 mm and about 20 mm is placed over the two-ply assemblage 104 to form a three ply assemblage 108 (FIGS. 17 and 18). The three ply assemblage thus formed is then compressed in a manner to urge the inner surface 106a of membrane 106 into engagement with the outer surface 102a of the inner membrane 102. This compression step is accomplished much in the same manner as previously described using the platen press shown in FIG. 12 of the drawings. This step in this latest form of the method of the invention activates the adhesive so as to securely and simultaneously bond together the adhesive-coated assemblage 104 and the outer membrane 106 to form a cured three-ply sub-assembly 108. With the construction thus described, the insulated heating harness 73 is encapsulated between two elastomeric membranes, namely membranes 102 and 106.

Next, while the cured three-ply sub-assembly remains in position over the mandrel “M”, the exposed surface of the cured three-ply sub-assembly is coated with a heat-activated, thermo-setting adhesive to form a coated, cured three-ply sub-assembly. This done, the adhesive is then fused to the exposed surface in a manner well understood by those skilled in the art through the use of a radiant heater operating at a temperature sufficient to activate the adhesive. Next, the outer covering 110 is placed over the coated, cured three-ply sub-assembly 108 in the manner illustrated in FIGS. 17 and 18 to form a precursor electrically heated glove. The four-ply assemblage is then compressed in a manner to urge the inner surface 110a of the outer covering 110 into engagement with the outer surface of the membrane 106 (FIG. 18). Once again, this compression step is accomplished much in the same manner as previously described using the platen press shown in FIG. 16 of the drawings. More particularly, with both platens 78 and 80 heated to a temperature of about 375° F., which is sufficient to bond the outer covering 110 to the adhesive-coated membrane 106, the assemblage is placed under compression for several minutes. This step in the method of the invention activates the adhesive so as to securely and simultaneously bond together the outer covering 110 to the adhesive-coated membrane 106 to thus form a cured or-ply sub-assembly.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An electrical heating apparatus for use in heating articles of apparel comprising:
(a) an elongated, negative bus constructed from a flexible electrically conductive material;
(b) an elongated, positive bus constructed from a flexible electrically conductive material;
(c) a heater arm having a plurality of interconnected segments, each segment comprising a yarn having plurality of strands of silver-plated yarn said heater arm having first extremity connected to negative bus and a second extremity connected to positive bus.

2. The apparatus as defined in claim 1 further including a controller assembly connected said negative and positive buses for controlling the flow of electricity thereto.

3. The apparatus as defined in claim 1 in which said yarn further comprises a strand of stretchable material.

4. The apparatus as defined in claim 1 in which said plurality of silver-plated strands of yarn comprise silver-plated nylon.

5. The apparatus as defined in claim 1 in which said flexible electrically conductive material from which said busses are constructed comprises silver-plated strands of yarn.

6. An electrically heated article of apparel comprising:
(a) an inner liner portion;
(b) an outer liner portion superimposed over said inner liner portion; and
(c) an electrical heating harness disposed between said inner liner portion and said outer portion, said electrical heating harness comprising:
(i) an elongated, negative bus constructed from a flexible electrically conductive material;
(ii) an elongated, positive bus constructed from a flexible electrically conductive material; and
(iii) a plurality of heater arms, each having a plurality of interconnected segments, each segment comprising a yarn having plurality of strands of silver-plated yarn said heater arm having first extremity connected to negative bus and a second extremity connected to positive bus.

7. The article as defined in claim 1 further including a controller assembly connected to said negative and positive buses of said heating harness for controlling the flow of electricity thereto.

8. The article as defined in claim 1 in which said inner liner is constructed from fabric.

9. The article as defined in claim 1 in which said inner liner is constructed from an elastomer.

10. The article as defined in claim 1 in which said outer liner is constructed from fabric.

11. The article as defined in claim 1 in which said outer liner is constructed from an elastomer.

12. The article as defined in claim 1 in which said plurality of silver-plated strands of yarn of said segments of said heater arms comprise silver-plated nylon;

13. The article as defined in claim 1 in which said yarn used to construct said segments of said heater arms further comprises a strand of stretchable material.

14. The article as defined in claim 1 in which said flexible electrically conductive material from which said busses are constructed comprises silver-plated strands of yarn.

15. A method of making an electrically heated article of apparel comprising a liner portion having an inner surface and an outer surface, said method comprising the steps of:
(a) constructing a flexible heating harness comprising a positive bus, a spaced-apart negative bus and a plurality of elongated, stretchable heater arms connected to and spanning said positive and negative buses, each said stretchable heater arm comprising a plurality of interconnected segments, each segment comprising a plurality of silver-plated strands of yarn;
(b) interconnecting said flexible heating harness with the liner portion to form a first sub-assembly; and
(c) interconnecting said flexible heating harness of said first sub-assembly with a source of electrical power.

16. The method as defined in claim 15 in which said flexible heating harness further comprises a connector element for inter-connection therewith of a controller assembly that includes a source of electrical energy.

17. The method as defined in claim 16, including the further step of prior to interconnecting said silver-coated harness with said liner portion, coating said silver-coated heating harness with an insulating material.

18. The method as defined in claim 16 in which the electrically heated article of apparel further comprises an outer portion and in which said method includes the further step of interconnecting said first sub-assembly with said outer portion.

19. The method as defined in claim 12 in which the electrically heated article of apparel comprises a glove.

20. A method of making an electrically heated glove constructed of an outer portion having an inner face and an outer face and a liner portion having an inner surface and an outer surface, said method comprising the steps of:
(a) constructing a flexible heating harness comprising a positive bus, a spaced-apart negative bus and a plurality of elongated, stretchable heater arms connected to and spanning said positive and negative buses, each said positive bus, said spaced-apart negative bus and said stretchable heater arms being constructed from a plurality of silver-plated strands of yarn;
(b) placing the liner portion over a planar mandrel with said first face thereof being located adjacent said mandrel to form a first sub-assembly;
(c) coating said heating harness with an adhesive to form a coated, insulated heating harness;
(d) placing said coated, heating harness over said first sub-assembly to form a second sub-assembly having an outer surface;
(e) coating said outer surface of said second sub-assembly with an adhesive to form a coated second sub-assembly;
(f) placing the outer portion over said coated second sub-assembly with said inner face thereof in engagement with said coated second sub-assembly; and
(g) compressing said coated second sub-assembly to urge said outer fabric portion into engagement with said coated second sub-assembly to form a precursor article.

21. The method as defined in claim 20 in which said plurality of silver plated strands of yarn comprise Spandex and silver-coated nylon filaments.

22. The method as defined in claim 20 in which said adhesive is thermo-setting and in which said method includes the further step of heating said precursor article during the compressing step to a temperature sufficient to bond said outer fabric portion to said coated second sub-assembly.

23. The method as defined in claim 20 in which said insulation comprises an ultra-violet cured polyurethane elastomeric polymer.

24. The method as defined in claim 20 including the further step of connecting to said flexible heating harness assembly to form a precursor heating harness, a connector element for inter-connection therewith of a controller assembly, that includes a source of electrical energy.

25. The method as defined in claim 24 including the further step, of interconnecting said controller assembly with said connector element of said precursor heating harness.
